(19) United States
(12) Patent Application Publication
(10) Pub. No.: US 2026/0325370 A1
(43) Pub. Date: Oct. 22, 2026

(54) FOLDABLE WHEELCHAIR

(71) Applicant: Guangdong Prestige Technology Company Limited, Dongguan, Guangdong (CN)

(72) Inventor: Zhao Zhang, Dongguan, Guangdong (CN)

(21) Appl. No.: 19/483,976

(22) PCT Filed: May 30, 2024
(86) PCT No.: PCT/CN2024/096383

§ 371 Date: Nov. 12, 2025

(30) Foreign Application Priority Data
May 31, 2023 (CN) 202310639718.4

(51) Int. Cl. A61G 5/08

(52) U.S. Cl. CPC A61G 5/085

(57) ABSTRACT

A foldable wheelchair includes a front frame, a rear frame, a seat plate, a drive mechanism, a first drive assembly and a second drive assembly. The front frame is pivotally connected to the rear frame, the seat plate is pivotally connected to the rear frame, the drive mechanism is arranged on the rear frame, the drive mechanism is connected to the first drive assembly, and the other end of the first drive assembly is connected to the seat plate to drive the seat plate to fold towards to the rear frame. The drive mechanism is connected to the second drive assembly, and another end of the second drive assembly is connected to the front frame to drive the front frame to fold towards to the rear frame. The foldable wheelchair of the present invention has the advantages of being simple to fold and convenient to use.

### FIELD OF THE INVENTION

The present invention relates to a wheelchair, and more particularly to a foldable wheelchair.

### BACKGROUND OF THE INVENTION

Wheelchairs generally have a large volume and are often folded to reduce their size for convenient storage. However, the folding frame designs of existing foldable wheelchairs are relatively complex, requiring multiple folding actions and involving cumbersome operations. Consequently, for individuals with limited mobility or advanced age, the use is insufficiently convenient.

### SUMMARY OF THE INVENTION

A first object of the present invention is to provide a foldable wheelchair that is simple to fold and convenient to use.

A second object of the present invention is to provide a foldable wheelchair that is simple to fold and convenient to use.

A third object of the present invention is to provide a foldable wheelchair that is simple to fold and convenient to use.

A fourth object of the present invention is to provide a foldable wheelchair that is simple to fold and convenient to use.

To achieve the aforesaid objects, the foldable wheelchair provided by the present invention includes a front frame, a rear frame, a seat plate, a drive mechanism, a first drive assembly, and a second drive assembly. The front frame is pivotally connected to the rear frame. The seat plate is pivotally connected to the rear frame. The drive mechanism is configured on the rear frame. An output end of the drive mechanism is connected to one end of the first drive assembly. Another end of the first drive assembly is connected to the seat plate, configured to drive the seat plate to fold towards the rear frame. The output end of the drive mechanism is connected to one end of the second drive assembly. Another end of the second drive assembly is connected to the front frame, configured to drive the front frame to fold towards the rear frame.

Compared with the prior art, in the present invention, the front frame and the seat plate are pivotally connected to the rear frame, the drive mechanism is configured on the rear frame, the first drive assembly is provided between the first swing arm and the seat plate, and the second drive assembly is provided between the second swing arm and the front frame. Therefore, by utilizing the drive mechanism to drive the first drive assembly, the seat plate is driven to unfold or fold relative to the rear frame. Simultaneously, the drive mechanism drives the second drive assembly, thereby driving the front frame to unfold or fold relative to the rear frame. Consequently, the entire foldable wheelchair can be unfolded or folded, with the entire unfolding or folding process performed in an interlinked manner, resulting in simple folding and ease of use.

Preferably, the drive mechanism includes a drive device and a first swing arm. One end of the drive device is pivotally connected to the rear frame, and another end of the drive device is pivotally connected to one end of the first swing arm. Another end of the first swing arm is pivotally connected to the one end of the first drive assembly.

Specifically, the first drive assembly includes a drive rod, a pivot member, and a link rod. One end of the drive rod is pivotally connected to the first swing arm, and another end of the drive rod is pivotally connected to the pivot member. The pivot member is pivotally connected to the rear frame. One end of the link rod is pivotally connected to the pivot member, and another end of the link rod is pivotally connected to the seat plate. By arranging the drive rod, the pivot member, and the link rod, the swinging force transmitted from the first swing arm can be converted into a downward pulling force on the seat plate, thereby driving the seat plate to fold towards the rear frame.

Specifically, the drive mechanism further includes a second swing arm. The first swing arm is fixedly connected to the second swing arm, and one end of the second swing arm is pivotally connected to the rear frame. The second swing arm is pivotally connected to the second drive assembly.

Preferably, the drive mechanism includes a drive device and a second swing arm. One end of the drive device is pivotally connected to the rear frame, and another end of the drive device is pivotally connected to one end of the second swing arm. The second swing arm is pivotally connected to the second drive assembly.

Preferably, the second drive assembly includes a first pull rod. One end of the first pull rod is pivotally connected to the second swing arm, and another end of the first pull rod is pivotally connected to the front frame. By providing the first pull rod, the swinging force transmitted by the second swing arm can be converted into a pulling force on the front frame, thereby driving the front frame to fold towards the rear frame.

Preferably, the foldable wheelchair further includes an armrest mechanism and a third drive assembly. The armrest mechanism is configured on the rear frame. One end of the third drive assembly is connected to the output end of the drive mechanism. Another end of the third drive assembly is connected to the armrest mechanism, configured to drive an armrest to fold towards the rear frame. By providing the third drive assembly, the armrest mechanism can be unfolded or folded synchronously with the seat plate and the front frame, making the folding process very simple and greatly improving user convenience.

Specifically, the armrest mechanism includes an armrest, a first link, and a second link. The first link and the second link are respectively pivotally connected to the rear frame. The other end of the third drive assembly is pivotally connected to one of the first link and the second link via a sliding shaft. Two ends of the armrest are pivotally connected to an upper end of the first link and an upper end of the second link, respectively. By arranging the first link and the second link between the armrest and the rear frame, a variable quadrilateral structure is formed, allowing the armrest to be folded or unfolded by acting on either the first link or the second link. This structure is simple and easy to control.

Specifically, the third drive assembly includes a second pull rod. One end of the second pull rod is pivotally connected to the output end of the drive mechanism, and another end of the second pull rod is pivotally connected to the armrest mechanism via a sliding shaft. The second pull rod can convert the swinging force transmitted by the second swing arm into a pulling force on the first link or the second link, thereby driving the armrest mechanism to fold or unfold.

Preferably, the foldable wheelchair further includes a backrest, a third drive assembly, and a linkage mechanism. One end of the backrest is pivotally connected to the seat plate. One end of the third drive assembly is connected to the output end of the drive mechanism. Another end of the third drive assembly is pivotally connected to one end of the linkage mechanism via a sliding shaft. Another end of the linkage mechanism is pivotally connected to the backrest, configured to drive the backrest to fold towards the seat plate. By providing the third drive assembly and the linkage mechanism, the backrest can be unfolded or folded synchronously with the seat plate and the front frame, making the folding process very simple and greatly improving user convenience.

Specifically, the third drive assembly includes a second pull rod. One end of the second pull rod is pivotally connected to the output end of the drive mechanism, and another end of the second pull rod is connected to the sliding shaft. Utilizing the second pull rod and the linkage mechanism, a pushing force can be applied to the backrest, thereby driving the backrest to fold or unfold towards the seat plate.

Specifically, an upper end of the front frame is provided with an arc-shaped hole, and the sliding shaft slidably passes through the arc-shaped hole. The arc-shaped hole can limit the movement of the sliding shaft, ensuring its sliding stability.

Specifically, the linkage mechanism includes a first linkage rod, a second linkage rod, and a third linkage rod. One end of the first linkage rod is connected to the sliding shaft, and another end of the first linkage rod is pivotally connected to the second linkage rod. One end of the second linkage rod is pivotally connected to the seat plate, and another end of the second linkage rod is pivotally connected to one end of the third linkage rod. Another end of the third linkage rod is pivotally connected to the backrest. This arrangement allows the driving force from the third drive assembly to be synchronously transmitted to the backrest, enabling interlinked folding of the backrest and the seat plate.

Preferably, the foldable wheelchair further includes wheels, wherein the wheels are respectively configured on the front frame and the rear frame.

Preferably, the foldable wheelchair further includes a pedal, wherein the pedal is retractably disposed at a lower end of the front frame. The pedal provides a place for the user to rest their feet, thereby further enhancing user comfort.

Specifically, an output end of the drive device is telescopically disposed.

A foldable wheelchair includes a front frame, a rear frame, a seat plate, a drive mechanism, and a first drive assembly. The front frame is connected to the rear frame, and the seat plate is pivotally connected to the rear frame. The drive mechanism is configured on the rear frame, an output end of the drive mechanism is connected to one end of the first drive assembly, and another end of the first drive assembly is connected to the seat plate and configured to drive the seat plate to fold towards the rear frame.

A foldable wheelchair includes a front frame, a rear frame, a seat plate, a drive mechanism, a first drive assembly, an armrest mechanism, and a third drive assembly. The front frame is connected to the rear frame, and the seat plate is pivotally connected to the rear frame. The drive mechanism is configured on the rear frame, an output end of the drive mechanism is connected to one end of the first drive assembly, and another end of the first drive assembly is connected to the seat plate and configured to drive the seat plate to fold towards the rear frame. The armrest mechanism is configured on the rear frame. One end of the third drive assembly is connected to the output end of the drive mechanism, and another end of the third drive assembly is connected to the armrest mechanism and configured to drive an armrest to fold towards the rear frame.

A foldable wheelchair includes a front frame, a rear frame, a seat plate, a drive mechanism, a second drive assembly, an armrest mechanism, and a third drive assembly. The front frame is pivotally connected to the rear frame, and the seat plate is configured on the rear frame. The drive mechanism is configured on the rear frame. An output end of the drive mechanism is connected to one end of the second drive assembly, and another end of the second drive assembly is pivotally connected to the front frame and configured to drive the front frame to fold towards the rear frame. The armrest mechanism is configured on the rear frame, and the output end of the drive mechanism is connected to one end of the third drive assembly. Another end of the third drive assembly is connected to the armrest mechanism and configured to drive an armrest to fold towards the rear frame.

### BRIEF DESCRIPTION OF THE DRAWINGS

FIG. 1 is a perspective view of a foldable wheelchair according to the present invention in an unfolded state.

FIG. 2 is an internal structural view of the foldable wheelchair according to the present invention.

FIG. 3 is a partial cross-sectional view of the internal structure of the foldable wheelchair according to the present invention.

FIG. 4 is a side view of the internal structure of the foldable wheelchair according to the present invention.

FIG. 5 is another side view of the internal structure of the foldable wheelchair according to the present invention.

FIG. 6 is a state diagram showing the internal structure of the foldable wheelchair in a partially folded state according to the present invention.

FIG. 7 is a state diagram showing the foldable wheelchair in a fully folded state according to the present invention.

### DETAILED DESCRIPTION OF ILLUSTRATED EMBODIMENTS

To provide a detailed explanation of the technical content, structural features, and achieved effects of the present invention, the following describes in detail with reference to embodiments and drawings.

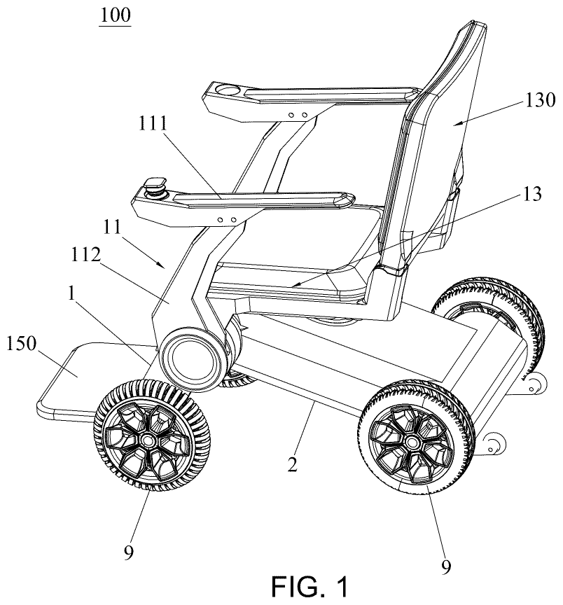

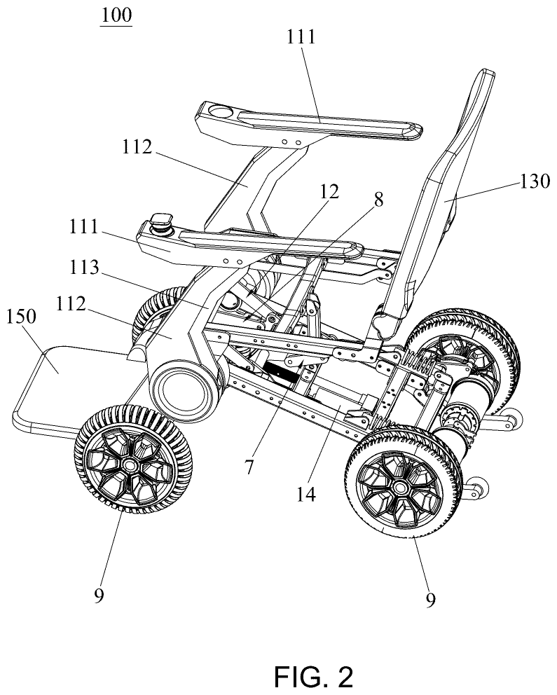

As shown in FIGS. 1 to 7, the structure of the foldable wheelchair 100 according to a first embodiment of the present invention is illustrated.

Referring to FIGS. 1 to 4, the foldable wheelchair 100 of the present invention includes a front frame 1, a rear frame 2, a seat plate 3, a drive mechanism, a first drive assembly 7, a second drive assembly 8, and wheels 9. An upper end of the front frame 1 is pivotally connected to a front end of the rear frame 2, forming an A-shaped structure, with a pivot point at ‘a’. The wheels 9 are disposed at a lower end of the front frame 1 and a rear end of the rear frame 2, respectively. A front end of the seat plate 3 is pivotally connected to the front end of the rear frame 2, and its pivot shaft is coaxial with the pivot shaft connecting the front frame 1 and the rear frame 2. The drive mechanism is configured on the rear frame 2. An output end of the drive mechanism is connected to one end of the first drive assembly 7 and one end of the second drive assembly 8, respectively. Specifically, the drive mechanism includes a drive device 4, a first swing arm 5, and a second swing arm 6. One end of the drive device 4 is pivotally connected to the rear frame 2 at a pivot point ‘b’, and another end of the drive device 4 is pivotally connected to one end of the first swing arm 5 at a pivot point ‘c’. The drive device 4 is an automatic actuator, and its output end is telescopically disposed. In this embodiment, the drive device 4 is an electric push rod. A middle portion of the first swing arm 5 and a middle portion of the second swing arm 6 are fixedly connected to each other via a connecting shaft 10. One end of the second swing arm 6 is pivotally connected to the rear frame 2 at a pivot point ‘d’. Another end of the first swing arm 5 is pivotally connected to one end of the first drive assembly 7 at a pivot point ‘e’. Another end of the first drive assembly 7 is pivotally connected to the seat plate 3 at a pivot point ‘f’, configured to drive the seat plate 3 to pivot about pivot point ‘a’ and fold towards the rear frame 2. Another end of the second swing arm 6 is pivotally connected to one end of the second drive assembly 8 at a pivot point ‘g’. Another end of the second drive assembly 8 is pivotally connected to the front frame 1 at a pivot point ‘h’, configured to drive the front frame 1 to pivot about pivot point ‘a’ and fold towards the rear frame 2.

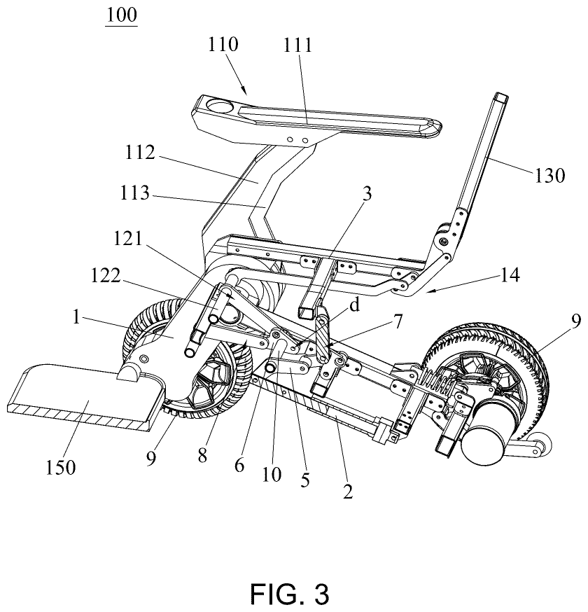

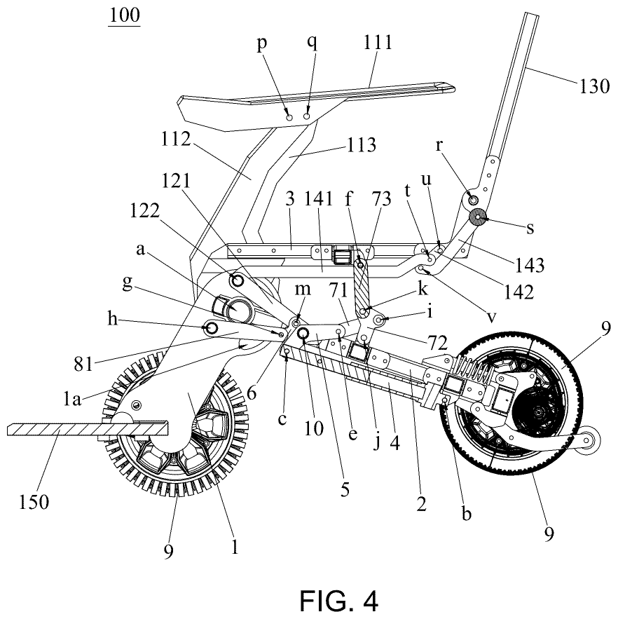

Specifically, referring to FIGS. 3 and 4, the first drive assembly 7 includes a drive rod 71, a pivot member 72, and a connecting rod 73. One end of the drive rod 71 is pivotally connected to the first swing arm 5 at pivot point ‘e’, and another end of the drive rod 71 is pivotally connected to the pivot member 72 at a pivot point ‘i’. The pivot member 72 is pivotally connected to the rear frame 2 at a pivot point ‘j’. One end of the connecting rod 73 is pivotally connected to the pivot member 72 at a pivot point ‘k’, and another end of the connecting rod 73 is pivotally connected to the seat plate 3 at pivot point ‘f’. By arranging the drive rod 71, the pivot member 72, and the connecting rod 73, the swinging force transmitted from the first swing arm 5 can be converted into a downward pulling force on the seat plate 3, thereby driving the seat plate 3 to fold towards the rear frame 2.

Again referring to FIGS. 3 and 4, the second drive assembly 8 includes a first pull rod 81. One end of the first pull rod 81 is pivotally connected to the second swing arm 6 at pivot point ‘g’, and another end of the first pull rod 81 is pivotally connected to the front frame 1 at pivot point ‘h’. By providing the first pull rod 81, the swinging force transmitted by the second swing arm 6 can be converted into a pulling force on the front frame 1, thereby driving the front frame 1 to fold towards the rear frame 2.

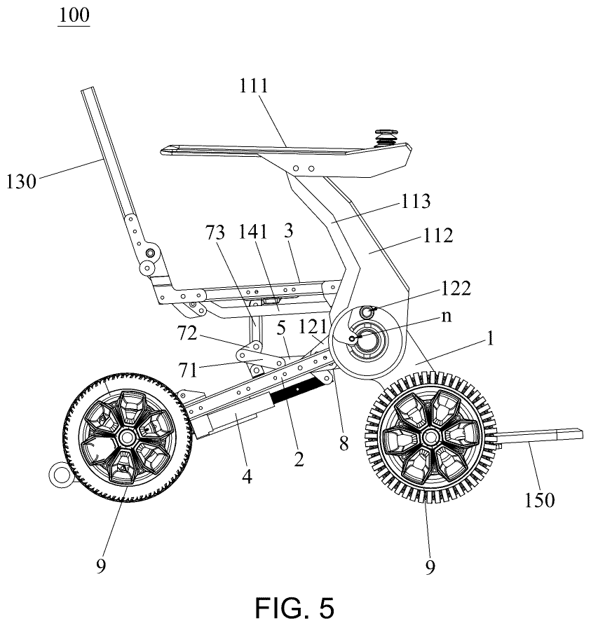

As shown in FIGS. 4 and 5, the foldable wheelchair 100 further includes an armrest mechanism 110 and a third drive assembly 120. The armrest mechanism 110 is configured on the rear frame 2. One end of the third drive assembly 120 is connected to the output end of the drive mechanism. Specifically, one end of the third drive assembly 120 is pivotally connected to the second swing arm 6 at a pivot point ‘m’. Another end of the third drive assembly 120 is connected to the armrest mechanism 110, configured to drive an armrest 111 to fold towards the rear frame 2. By providing the third drive assembly 120, the armrest mechanism 110 can be unfolded or folded synchronously with the seat plate 3 and the front frame 1, making the folding process very simple and greatly improving user convenience. The armrest mechanism 110 includes the armrest 111, a first link 112, and a second link 113. The first link 112 and the second link 113 are pivotally connected to the rear frame 2, respectively. Specifically, a lower end of the first link 112 has a ring-like structure, and this ring-like structure is coaxial with the central axis of pivot point ‘a’. The pivot points of the second link 113 and the rear frame 2 are denoted as ‘n’, respectively. The other end of the third drive assembly 120 is pivotally connected to one of the first link 112 and the second link 113 via a sliding shaft 122. Two ends of the armrest 111 are pivotally connected to an upper end of the first link 112 and an upper end of the second link 113 at pivot points ‘p’ and ‘q’, respectively. By arranging the first link 112 and the second link 113 between the armrest 111 and the rear frame 2, a variable quadrilateral structure is formed, allowing the armrest 111 to be folded or unfolded by acting on either the first link 112 or the second link 113. Such a structure is simple and easy to control.

Referring to FIG. 4, the third drive assembly 120 includes a second pull rod 121. One end of the second pull rod 121 is pivotally connected to the second swing arm 6 at pivot point ‘m’, and another end of the second pull rod 121 is pivotally connected to the armrest mechanism 110 via the sliding shaft 122. The second pull rod 121 can convert the swinging force transmitted by the second swing arm 6 into a pulling force on the first link 112 or the second link 113, thereby achieving the objective of driving the armrest mechanism 110 to fold or unfold.

Again referring to FIG. 4, the foldable wheelchair 100 further includes a backrest 130 and a linkage mechanism 140. One end of the backrest 130 is pivotally connected to the seat plate 3 at a pivot point ‘r’. One end of the linkage mechanism 140 is pivotally connected to the third drive assembly 120 via the sliding shaft 122. Another end of the linkage mechanism 140 is pivotally connected to the backrest 130 at a pivot point ‘s’, configured to drive the backrest 130 to pivot about pivot point ‘r’ and fold towards the seat plate 3. By providing the linkage mechanism 140, the backrest 130 can be unfolded or folded synchronously with the seat plate 3 and the front frame 1, making the folding process simple and greatly improving user convenience. More specifically, the linkage mechanism 140 includes a first linkage rod 141, a second linkage rod 142, and a third linkage rod 143. One end of the first linkage rod 141 is connected to the sliding shaft 122, and another end of the first linkage rod 141 is pivotally connected to a middle portion of the second linkage rod 142 at a pivot point ‘t’. One end of the second linkage rod 142 is pivotally connected to a rear end of the seat plate 3 at a pivot point ‘u’, and another end of the second linkage rod 142 is pivotally connected to one end of the third linkage rod 143 at a pivot point ‘v’. Another end of the third linkage rod 143 is pivotally connected to the backrest 130 at pivot point ‘s’. This arrangement allows the driving force from the third drive assembly 120 to be synchronously transmitted to the backrest 130, thereby enabling interlinked folding of the backrest 130 and the seat plate 3.

As shown in FIG. 4, a side wall at an upper end of the front frame 1 is provided with a penetrating arc-shaped hole 1a. The arc-shaped hole 1a has a central angle of approximately 180 degrees and is located on a side of the front frame 1 proximate to the rear frame 2. The sliding shaft 122 slidably passes through the arc-shaped hole 1a. The arc-shaped hole 1a can limit the movement of the sliding shaft 122, ensuring its sliding stability.

Again referring to FIG. 1, the foldable wheelchair 100 further includes a pedal 150. The pedal 150 is retractably disposed at a lower end of the front frame 1. The pedal 150 provides a place for the user to rest their feet, further enhancing user comfort.

With reference to FIGS. 4, 6, and 7, the working principle of the foldable wheelchair 100 of the present invention is described in detail as follows.

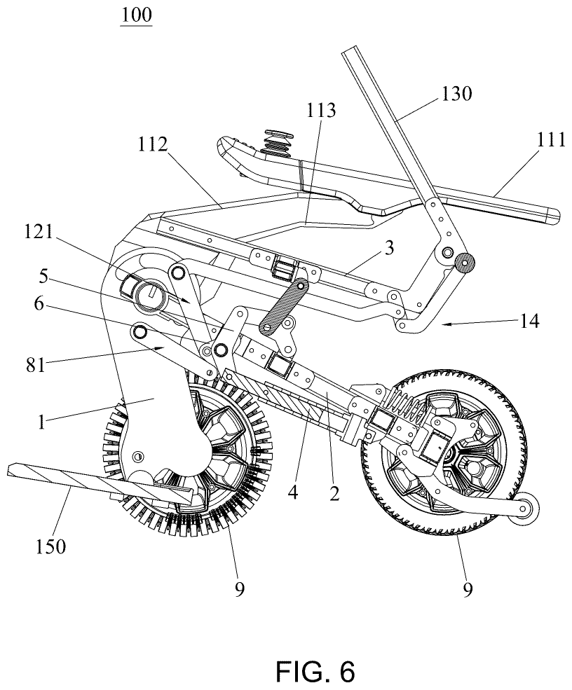

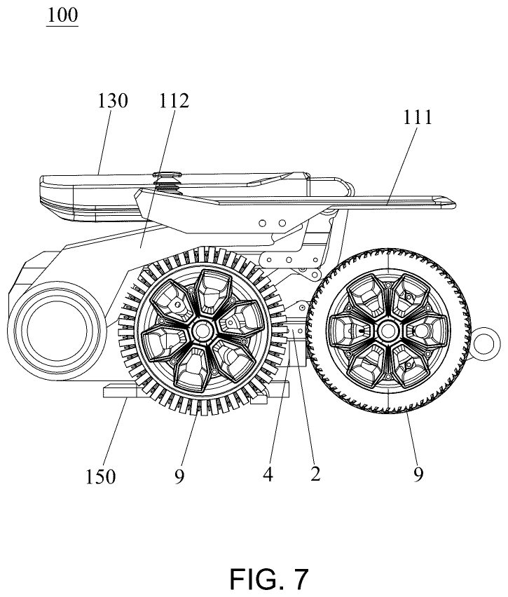

Referring to FIG. 4 first, the state of various members when the foldable wheelchair 100 is unfolded is shown. Then, referring to FIG. 6, when folding is required, the electric push rod is activated, causing the telescopic end of the electric push rod to retract. The electric push rod drives the first swing arm 5, the connecting shaft 10, and the second swing arm 6 to pivot about pivot point ‘d’. At this time, the other end of the first swing arm 5 drives the first drive assembly 7, while simultaneously, the second swing arm 6 drives the second drive assembly 8 and the third drive assembly 120 to actuate. Specifically, the drive rod 71 pulls the pivot member 72, causing it to pivot about pivot point ‘j’. The pivot member 72 drives the connecting rod 73, causing the connecting rod 73 to pull the seat plate 3, thereby making the seat plate 3 swing towards the rear frame 2. Simultaneously, driven by the second swing arm 6, the first pull rod 81 drives the front frame 1, causing the front frame 1 to swing towards the rear frame 2. Furthermore, driven by the second swing arm 6, the second pull rod 121 drives the sliding shaft 122 to slide along the arc-shaped hole 1a. At this time, the sliding shaft 122 drives the first link 112 to pivot about pivot point ‘a’ and move towards the rear frame 2, while simultaneously, under the linkage effect, the second link 113 pivots about pivot point(s) ‘n’ and moves towards the rear frame 2. Concurrently, the sliding shaft 122 pushes the first linkage rod 141. The first linkage rod 141 pushes the second linkage rod 142 to swing rearward about pivot point ‘u’. The second linkage rod 142 drives the third linkage rod 143, causing the third linkage rod 143 to push the backrest 130 to pivot about pivot point ‘r’, making the backrest 130 fold towards the seat plate 3. Then, as shown in FIG. 7, when the output end of the electric push rod is fully retracted, the seat plate 3, the front frame 1, the armrest 111, and the backrest 130 can be fully folded against the rear frame 2. At this point, the foldable wheelchair 100 is completely folded. When it is necessary to unfold the foldable wheelchair 100, the output end of the electric push rod is controlled to extend. At this time, the movements of the various members are opposite to the folding movements described above. Finally, after the output end of the electric push rod is fully extended, the foldable wheelchair 100 can be completely unfolded.

Compared with the prior art, in the present invention, the front frame 1 and the seat plate 3 are pivotally connected to the rear frame 2, the interconnected first swing arm 5 and second swing arm 6 are configured on the rear frame 2, and further the first drive assembly 7 is provided between the first swing arm 5 and the seat plate 3, and the second drive assembly 8 is provided between the second swing arm 6 and the front frame 1. Therefore, by utilizing the drive device 4 to drive the first swing arm 5 and the second swing arm 6, the first swing arm 5 drives the first drive assembly 7, thereby driving the seat plate 3 to unfold or fold relative to the rear frame 2. Simultaneously, the second swing arm 6 drives the second drive assembly 8, thereby driving the front frame 1 to unfold or fold relative to the rear frame 2. Furthermore, the third drive assembly 120 is provided between the second swing arm 6 and the armrest mechanism 110, and the linkage mechanism 140 is provided between the third drive assembly 120 and the backrest 130, enabling the foldable wheelchair 100 to simultaneously fold the armrest 111 and the backrest 130. Consequently, the entire foldable wheelchair 100 can be unfolded or folded, with the entire unfolding or folding process performed in an interlinked manner, resulting in simple folding and great ease of use.

Additionally, the foldable wheelchair 100 of the present invention further provides a second embodiment, specifically as follows.

The foldable wheelchair 100 of the second embodiment includes a front frame 1, a rear frame 2, a seat plate 3, a drive mechanism, and a first drive assembly 7. The drive mechanism includes a drive device 4 and a first swing arm 5. The structures of the front frame 1, rear frame 2, seat plate 3, drive device 4, first swing arm 5, and first drive assembly 7 are the same as those in the first embodiment. The front frame 1 is connected to the rear frame 2. The seat plate 3 is pivotally connected to the rear frame 2. The drive mechanism is configured on the rear frame 2. The output end of the drive mechanism is connected to one end of the first drive assembly 7. Specifically, one end of the drive device 4 is pivotally connected to the rear frame 2, and another end of the drive device 4 is pivotally connected to one end of the first swing arm 5. The first swing arm 5 is pivotally connected relative to the rear frame 2. Another end of the first swing arm 5 is pivotally connected to one end of the first drive assembly 7. Another end of the first drive assembly 7 is pivotally connected to the seat plate 3, configured to drive the seat plate 3 to fold towards the rear frame 2. This embodiment allows the seat plate 3 to be folded, providing simple folding and ease of use.

The foldable wheelchair 100 of the present invention further provides a third embodiment, specifically as follows.

The foldable wheelchair 100 of this embodiment includes a front frame 1, a rear frame 2, a seat plate 3, a drive mechanism, a first drive assembly 7, an armrest mechanism 110, and a third drive assembly 120. The drive mechanism includes a drive device 4, a first swing arm 5, and a second swing arm 6. The structures of the front frame 1, rear frame 2, seat plate 3, drive device 4, first swing arm 5, second swing arm 6, first drive assembly 7, armrest mechanism 110, and third drive assembly 120 are the same as those in the first embodiment. The front frame 1 is connected to the rear frame 2. The seat plate 3 is pivotally connected to the rear frame 2. The drive mechanism is configured on the rear frame 2. The output end of the drive mechanism is connected to one end of the first drive assembly 7 and one end of the third drive assembly 120, respectively. Specifically, one end of the drive device 4 is pivotally connected to the rear frame 2, and another end of the drive device 4 is pivotally connected to one end of the first swing arm 5. The first swing arm 5 is fixedly connected to the second swing arm 6, and the second swing arm 6 is pivotally connected to the rear frame 2. Another end of the first swing arm 5 is pivotally connected to one end of the first drive assembly 7. Another end of the first drive assembly 7 is pivotally connected to the seat plate 3, configured to drive the seat plate 3 to fold towards the rear frame 2. The armrest mechanism 110 is configured on the rear frame 2. One end of the third drive assembly 120 is pivotally connected to the second swing arm 6, and another end of the third drive assembly 120 is connected to the armrest mechanism 110, configured to drive the armrest 111 to fold towards the rear frame 2. This embodiment allows the seat plate 3, the armrest 111, and the backrest 130 to be folded, providing simple folding and ease of use.

The foldable wheelchair 100 of the present invention further provides a fourth embodiment, specifically as follows.

The foldable wheelchair 100 of this embodiment includes a front frame 1, a rear frame 2, a seat plate 3, a drive mechanism, a second drive assembly 8, an armrest mechanism 110, and a third drive assembly 120. The drive mechanism includes a drive device 4, a first swing arm 5, and a second swing arm 6. The front frame 1, rear frame 2, seat plate 3, drive device 4, first swing arm 5, second swing arm 6, second drive assembly 8, armrest mechanism 110, and third drive assembly 120 have the same structures as those in the first embodiment. The front frame 1 is pivotally connected to the rear frame 2. The seat plate 3 is configured on the rear frame 2. The drive mechanism is configured on the rear frame 2. The output end of the drive mechanism is connected to one end of the second drive assembly 8 and one end of the third drive assembly 120, respectively. Specifically, one end of the drive device 4 is pivotally connected to the rear frame 2, and another end of the drive device 4 is pivotally connected to one end of the first swing arm 5. The first swing arm 5 is fixedly connected to the second swing arm 6, and one end of the second swing arm 6 is pivotally connected to the rear frame 2. Another end of the second swing arm 6 is pivotally connected to one end of the second drive assembly 8. Another end of the second drive assembly 8 is pivotally connected to the front frame 1, configured to drive the front frame 1 to fold towards the rear frame 2. The armrest mechanism 110 is configured on the rear frame 2. One end of the third drive assembly 120 is pivotally connected to the second swing arm 6, and another end of the third drive assembly 120 is connected to the armrest mechanism 110, configured to drive the armrest 111 to fold towards the rear frame 2. This embodiment allows the front frame 1 and the armrest 111 to be folded, providing simple folding and ease of use.

The above descriptions are merely preferred embodiments of the present invention and are not intended to limit the scope of the invention. Any modifications, equivalent substitutions, or improvements made within the spirit and principles of the present invention should be included within the protection scope of the present invention.

1. A foldable wheelchair, comprising a front frame, a rear frame, a seat plate, a drive mechanism, a first drive assembly, and a second drive assembly;
wherein the front frame is pivotally connected to the rear frame, the seat plate is pivotally connected to the rear frame, the drive mechanism is configured on the rear frame, an output end of the drive mechanism is connected to one end of the first drive assembly, and another end of the first drive assembly is connected to the seat plate and configured to drive the seat plate to fold towards the rear frame; the output end of the drive mechanism is further connected to one end of the second drive assembly, and another end of the second drive assembly is connected to the front frame and configured to drive the front frame to fold towards the rear frame;
wherein the drive mechanism comprises a drive device and a first swing arm, one end of the drive device is pivotally connected to the rear frame, another end of the drive device is pivotally connected to one end of the first swing arm, and another end of the first swing arm is pivotally connected to the one end of the first drive assembly;
wherein the first drive assembly comprises a drive rod, a pivot member, and a link rod; one end of the drive rod is pivotally connected to the first swing arm, and another end of the drive rod is pivotally connected to the pivot member; the pivot member is pivotally connected to the rear frame; one end of the link rod is pivotally connected to the pivot member, and another end of the link rod is pivotally connected to the seat plate;
wherein the drive mechanism further comprises a second swing arm, the first swing arm is fixedly connected to the second swing arm, one end of the second swing arm is pivotally connected to the rear frame, and the second swing arm is pivotally connected to the second drive assembly.

2-5. (canceled)

6. The foldable wheelchair according to claim 1, wherein the second drive assembly comprises a first pull rod, one end of the first pull rod is pivotally connected to the second swing arm, and another end of the first pull rod is pivotally connected to the front frame.

7. The foldable wheelchair according to claim 1, further comprising an armrest mechanism and a third drive assembly, the armrest mechanism is configured on the rear frame, one end of the third drive assembly is connected to the output end of the drive mechanism, and another end of the third drive assembly is connected to the armrest mechanism and configured to drive an armrest to fold towards the rear frame.

8. The foldable wheelchair according to claim 7, wherein the armrest mechanism comprises an armrest, a first link and a second link, the first link and the second link are respectively pivotally connected to the rear frame, the another end of the third drive assembly is pivotally connected to one of the first link and the second link via a sliding shaft, and two ends of the armrest are pivotally connected to an upper end of the first link and an upper end of the second link, respectively.

9. The foldable wheelchair according to claim 7, wherein the third drive assembly comprises a second pull rod, one end of the second pull rod is pivotally connected to the output end of the drive mechanism, and another end of the second pull rod is pivotally connected to the armrest mechanism via a sliding shaft.

10. The foldable wheelchair according to claim 1, further comprising a backrest, a third drive assembly, and a linkage mechanism, wherein one end of the backrest is pivotally connected to the seat plate, one end of the third drive assembly is connected to the output end of the drive mechanism, another end of the third drive assembly is pivotally connected to one end of the linkage mechanism via a sliding shaft, and another end of the linkage mechanism is pivotally connected to the backrest and configured to drive the backrest to fold towards the seat plate.

11. The foldable wheelchair according to claim 10, wherein the third drive assembly comprises a second pull rod, one end of the second pull rod is pivotally connected to the output end of the drive mechanism, and another end of the second pull rod is connected to the sliding shaft.

11. The foldable wheelchair according to claim 8, wherein an upper end of the front frame is provided with an arc-shaped hole, and the sliding shaft slidably passes through the arc-shaped hole.

13. The foldable wheelchair according to claim 10, wherein the linkage mechanism comprises a first linkage rod, a second linkage rod, and a third linkage rod, one end of the first linkage rod is connected to the sliding shaft, and another end of the first linkage rod is pivotally connected to the second linkage rod; one end of the second linkage rod is pivotally connected to the seat plate, and another end of the second linkage rod is pivotally connected to one end of the third linkage rod; and another end of the third linkage rod is pivotally connected to the backrest.

14. The foldable wheelchair according to claim 1, further comprising wheels, wherein the wheels are respectively configured on the front frame and the rear frame.

15. The foldable wheelchair according to claim 1, further comprising a pedal, wherein the pedal is retractably disposed at a lower end of the front frame.

16. The foldable wheelchair according to claim 1, wherein an output end of the drive device is telescopically disposed.

17. A foldable wheelchair, comprising a front frame, a rear frame, a seat plate, a drive mechanism, and a first drive assembly;
wherein the front frame is connected to the rear frame, the seat plate is pivotally connected to the rear frame, the drive mechanism is configured on the rear frame, an output end of the drive mechanism is connected to one end of the first drive assembly, and another end of the first drive assembly is connected to the seat plate and configured to drive the seat plate to fold towards the rear frame;
wherein the drive mechanism comprises a drive device and a first swing arm; one end of the drive device is pivotally connected to the rear frame, and another end of the drive device is pivotally connected to one end of the first swing arm; and another end of the first swing arm is pivotally connected to the one end of the first drive assembly;
wherein the first drive assembly comprises a drive rod, a pivot member, and a link rod; one end of the drive rod is pivotally connected to the first swing arm, and another end of the drive rod is pivotally connected to the pivot member; the pivot member is pivotally connected to the rear frame; one end of the link rod is pivotally connected to the pivot member, and another end of the link rod is pivotally connected to the seat plate.

18-19. (canceled)

20. The foldable wheelchair according to claim 17, further comprising a second swing arm, a backrest, a third drive assembly, and a linkage mechanism; wherein the first swing arm is fixedly connected to the second swing arm, the second swing arm is pivotally connected to the rear frame, one end of the backrest is pivotally connected to the seat plate, one end of the third drive assembly is pivotally connected to the second swing arm, another end of the third drive assembly is pivotally connected to one end of the linkage mechanism via a sliding shaft, and another end of the linkage mechanism is pivotally connected to the backrest and configured to drive the backrest to fold towards the seat plate.

21. A foldable wheelchair, comprising a front frame, a rear frame, a seat plate, a drive mechanism, a first drive assembly, an armrest mechanism, and a third drive assembly;
wherein the front frame is connected to the rear frame, the seat plate is pivotally connected to the rear frame, the drive mechanism is configured on the rear frame, an output end of the drive mechanism is connected to one end of the first drive assembly, another end of the first drive assembly is connected to the seat plate and configured to drive the seat plate to fold towards the rear frame, the armrest mechanism is configured on the rear frame, one end of the third drive assembly is connected to the output end of the drive mechanism, and another end of the third drive assembly is connected to the armrest mechanism and configured to drive an armrest to fold towards the rear frame;
wherein the drive mechanism comprises a drive device, a first swing arm, and a second swing arm, one end of the drive device is pivotally connected to the rear frame, another end of the drive device is pivotally connected to one end of the first swing arm, another end of the first swing arm is pivotally connected to the one end of the first drive assembly, the first swing arm is fixedly connected to the second swing arm, one end of the second swing arm is pivotally connected to the rear frame, and the second swing arm is pivotally connected to the third drive assembly;
wherein the first drive assembly comprises a drive rod, a pivot member, and a link rod, one end of the drive rod is pivotally connected to the first swing arm, another end of the drive rod is pivotally connected to the pivot member, the pivot member is pivotally connected to the rear frame, one end of the link rod is pivotally connected to the pivot member, and another end of the link rod is pivotally connected to the seat plate.

22-23. (canceled)

24. The foldable wheelchair according to claim 21, wherein the third drive assembly comprises a second pull rod, one end of the second pull rod is pivotally connected to the second swing arm, and another end of the second pull rod is pivotally connected to the armrest mechanism.

25. A foldable wheelchair, comprising a front frame, a rear frame, a seat plate, a drive mechanism, a second drive assembly, an armrest mechanism, and a third drive assembly;
wherein the front frame is pivotally connected to the rear frame, the seat plate is configured on the rear frame, the drive mechanism is configured on the rear frame, an output end of the drive mechanism is connected to one end of the second drive assembly, another end of the second drive assembly is pivotally connected to the front frame and configured to drive the front frame to fold towards the rear frame, the armrest mechanism is configured on the rear frame, the output end of the drive mechanism is connected to one end of the third drive assembly, and another end of the third drive assembly is connected to the armrest mechanism and configured to drive an armrest to fold towards the rear frame;
wherein the drive mechanism comprises a drive device, a first swing arm, and a second swing arm, one end of the drive device is pivotally connected to the rear frame, another end of the drive device is pivotally connected to one end of the first swing arm, the first swing arm is fixedly connected to the second swing arm, one end of the second swing arm is pivotally connected to the rear frame, and the second swing arm is pivotally connected to the second drive assembly and the third drive assembly, respectively.

26. (canceled)
